(19) United States
(12) Patent Application Publication
(10) Pub. No.: US 2025/0391612 A1
(43) Pub. Date: Dec. 25, 2025

(54) MULTILAYER CERAMIC CAPACITOR

(71) Applicant: Murata Manufacturing Co., Ltd., Nagaokakyo-shi (JP)

(72) Inventor: Keita AKASHI, Nagaokakyo-shi (JP)

(21) Appl. No.: 19/218,937

(22) Filed: May 27, 2025

(30) Foreign Application Priority Data
Jun. 21, 2024 (JP) 2024-100426

(51) Int. Cl. H01G 4/30; H01G 4/232

(52) U.S. Cl. CPC H01G 4/30; H01G 4/2325

(57) ABSTRACT

A multilayer ceramic capacitor includes a multilayer body including first and second surfaces facing each other in a height direction, third and fourth surfaces facing each other in a first direction, and fifth and sixth surfaces facing each other in a second direction, a first underlying electrode on the third, first, second, fifth, and sixth surfaces, and a second underlying electrode on the fourth, first, second, fifth, and sixth surfaces. The first underlying electrode includes a first-surface inside region on the first surface and extending about 1 μm or less from the first surface in the height direction, and a Ni concentration of the first-surface inside region is lower than that of an inside region on the third surface.

### CROSS REFERENCE TO RELATED APPLICATIONS

This application claims the benefit of priority to Japanese Patent Application No. 2024-100426 filed on Jun. 21, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

In a conventional multilayer ceramic capacitor, inner electrodes are mainly made of, for example, Ni or Cu, and outer electrodes are formed by firing metal paste of Cu or the like. On the other hand, inner electrodes of the multilayer ceramic capacitor according to Japanese Unexamined Patent Application Publication No. 2017-27987 are mainly made of Ni or Cu, and outer electrodes each include an underlying conductor film including an alloy of Cu and Ni and a glass component. According to the multilayer ceramic capacitor of Japanese Unexamined Patent Application Publication No. 2017-27987, when the metal and glass components are uniformly distributed in the underlying conductor film, stress generated during firing becomes uniform throughout the underlying conductor film, making it possible to prevent cracking in the multilayer body.

However, according to the multilayer ceramic capacitor of Japanese Unexamined Patent Application Publication No. 2017-27987, in the step of firing metal paste for the underlying conductor film including an alloy of Cu and Ni and a glass component, over-sintering of the metal paste may cause cracks inside the multilayer body. If the sintering conditions are relaxed to reduce over-sintering of the metal paste, insufficient sintering of the metal paste may increase the porosity in the outer electrodes, leading to deterioration in moisture resistance. Multilayer ceramic capacitors using a Ni—Cu alloy as the metal paste may have reduced moisture resistance compared to multilayer ceramic capacitors using Cu as the metal paste and may decrease in equivalent series resistance (ESR) when Ni is used for the inner electrodes.

### SUMMARY OF THE INVENTION

Example embodiments of the present invention provide multilayer ceramic capacitors that are each more resistant to cracking and have excellent moisture resistance.

An example embodiment of the present invention provides a multilayer ceramic capacitor including a multilayer body including a first surface and a second surface that face each other in a height direction, a third surface and a fourth surface that face each other in a first direction perpendicular or substantially perpendicular to the height direction, and a fifth surface and a sixth surface that face each other in a second direction perpendicular or substantially perpendicular to the height direction and the first direction, a first outer electrode on the third surface, the first surface, the second surface, the fifth surface, and the sixth surface, and a second outer electrode on the fourth surface, the first surface, the second surface, the fifth surface, and the sixth surface, in which the first outer electrode and the second outer electrode respectively include a first underlying electrode and a second underlying electrode including Cu, the first underlying electrode includes, a first-surface inside region on the first surface and extends about 1 μm or less from the first surface in the height direction, a second-surface inside region on the second surface and extends about 1 μm or less from the second surface in the height direction, a third-surface inside region on the third surface and extends about 1 μm or less from the third surface in the first direction, a fifth-surface inside region on the fifth surface and extends about 1 μm or less from the fifth surface in the second direction, and a sixth-surface inside region on the sixth surface and extends about 1 μm or less from the sixth surface in the second direction, the first-surface inside region and the third-surface inside region include Ni, and a Ni concentration of the first-surface inside region is lower than a Ni concentration of the third-surface inside region.

According to example embodiments of the present invention, it is possible to provide multilayer ceramic capacitors that are each more resistant to cracking and have excellent moisture resistance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to a first example embodiment of the present invention.

FIG. 2 is a partial sectional view of the multilayer ceramic capacitor 1 along line II-II in FIG. 1.

FIG. 3 is a sectional view of the multilayer ceramic capacitor 1 along line III-III in FIG. 1.

FIG. 4 is a flowchart of the method for manufacturing the multilayer ceramic capacitor 1 according to the first example embodiment of the present invention.

FIG. 5 is a table showing the results of board bending resistance and moisture resistance tests.

FIG. 6 is a schematic perspective view of a multilayer ceramic capacitor 100 according to a second example embodiment of the present invention.

FIG. 7 is a partial sectional view of the multilayer ceramic capacitor 100 along line VII-VII in FIG. 6.

FIG. 8 is a sectional view of the multilayer ceramic capacitor 100 along line VIII-VIII in FIG. 6.

### DETAILED DESCRIPTION OF THE EXAMPLE EMBODIMENTS

Example embodiments of the present invention will be described in detail below with reference to the drawings.

### First Example Embodiment

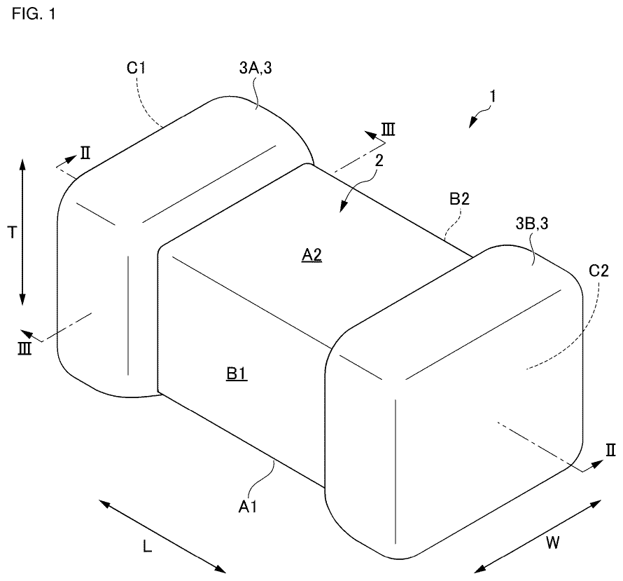

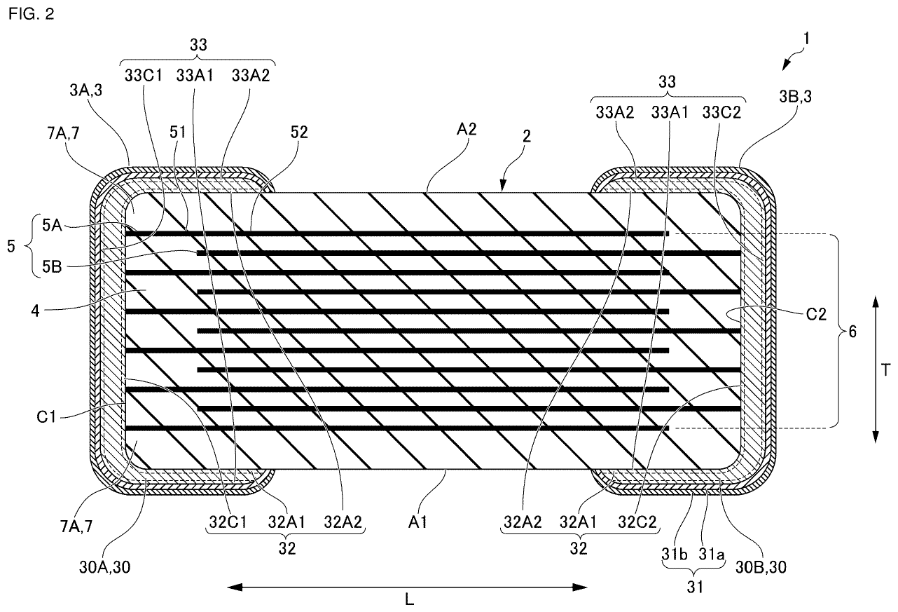

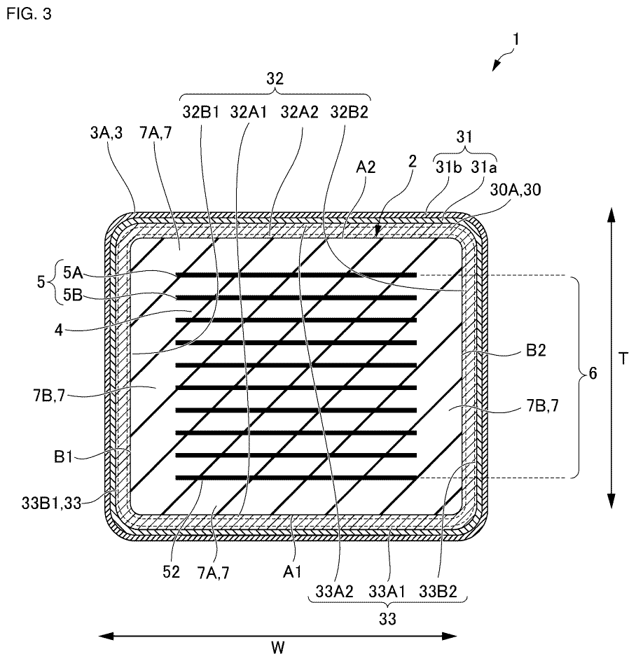

Hereinafter, a first example embodiment of the present invention will be described. FIG. 1 is a schematic perspective view of a multilayer ceramic capacitor 1 according to the first example embodiment. FIG. 2 is a partial sectional view of the multilayer ceramic capacitor 1 along line II-II in FIG. 1. FIG. 3 is a sectional view of the multilayer ceramic capacitor 1 along line III-III in FIG. 1.

The multilayer ceramic capacitor 1 includes a multilayer body 2, which has a rectangular or substantially rectangular parallelepiped shape, and a pair of outer electrodes 3, which are provided at both ends of the multilayer body 2. The multilayer body 2 includes an effective area 6, which includes plural pairs of dielectric layers 4 and inner electrodes 5.

In the following description, as a term to express the orientation of the multilayer ceramic capacitor 1, the direction perpendicular or substantially perpendicular to the mounting surface is referred to as a height direction T. In the first example embodiment, the stacking direction in which the inner electrodes 5 and the dielectric layers 4 are stacked on top of each other is the direction perpendicular or substantially perpendicular to the mounting surface, that is, the height direction T. However, the configuration is not limited to that, and the stacking direction in which the inner electrodes 5 and the dielectric layers 4 are stacked may be the direction horizontal relative to the mounting surface while the height direction T may be the direction perpendicular or substantially perpendicular to the stacking direction in which the inner electrodes 5 and the dielectric layers 4 are stacked.

The direction in which the pair of outer electrodes 3 are arranged is referred to as a first direction L. A second direction W refers to a direction that intersects both the first direction L and the height direction T. In the first example embodiment, the first direction L, the second direction W, and the height direction T are perpendicular or substantially perpendicular to each other.

### Multilayer Body 2

The multilayer body 2 has a hexahedron or substantially hexahedron shape including a first surface A1 and a second surface A2, which face each other in the height direction T, a third surface C1 and a fourth surface C2, which face each other in the first direction L, and a fifth surface B1 and a sixth surface B2, which face each other in the second direction W. In the first example embodiment, the first surface A1 defines and functions as the mounting surface that is attached to a substrate.

In the multilayer body 2, edge portions, which are regions between adjacent two surfaces, and corner portions, which are intersections of three adjacent surfaces, are preferably rounded. This can reduce or prevent chipping at angled portions of the multilayer body 2.

The multilayer body 2 includes the effective area 6 and an ineffective area 7. The effective area 6 is an area in which the inner electrodes 5 and the dielectric layers 4 are stacked on top of each other. The ineffective area 7 is an area in which the inner electrodes 5 are not provided. The ineffective area 7 includes outer layer portions 7A, which sandwich the effective area 6 in the height direction T, and side gap portions 7B, which sandwich the effective area 6 in the second direction W.

### Dielectric Layer 4

Preferably, the dielectric layers 4 include, as a component, for example, a BT-based or CZ-based ceramic material as the main component. The dielectric layers 4 may include a sintering agent as an additive.

### Inner Electrode 5

The inner electrodes 5 include plural first inner electrodes 5A and plural second inner electrodes 5B. The first inner electrodes 5A and the plural second inner electrodes 5B are alternately arranged. For example, the first inner electrodes 5A are exposed to the third surface C1, and the second inner electrodes 5B are exposed to the fourth surface C2. When it is not necessary to particularly distinguish between the first inner electrodes 5A and the second inner electrodes 5B, they are collectively described as the inner electrodes 5.

The inner electrodes 5 preferably include, as a component, a metal material represented by, but not particularly limited to, for example, nickel (Ni), copper (Cu), silver (Ag), palladium (Pd), silver-palladium (Ag—Pd) alloys, gold (Au), or the like. Including Sn in the interfaces between the inner electrodes 5 and the dielectric layers 4 can reduce the electric field concentration on the interfaces, thus improving the high-temperature load reliability. Sn exerts its effect even when Sn is included in either the first inner electrodes 5A or the second inner electrodes 5B, but not both.

The inner electrodes 5 include opposing portions 52 and extension portions 51. The opposing portions 52 of the first inner electrodes 5A face the opposing portions 52 of the second inner electrodes 5B. The extension portions 51 of the first inner electrodes 5A do not face the extension portions 51 of the second inner electrodes 5B and extend from the respective opposing portions 52 to the third surface C1 or the fourth surface C2. The direction in which the extension portions 51 extend differs between the first and second inner electrodes 5A and 5B, and the extension portions 51 alternately extend toward the third and fourth surfaces C1 and C2. End portions of the extension portions 51 of the first inner electrodes 5A are exposed to the third surface C1 and are electrically coupled to a first outer electrode 3A. End portions of the extension portions 51 of the second inner electrodes 5B are exposed to the fourth surface C2 and are electrically coupled to a second outer electrode 3B. Electric charges accumulate between the opposing portions 52 of the first and second inner electrodes 5A and 5B that are adjacent in the height direction T, and the effective area 6 thus defines and functions as a capacitor.

### Outer Layer Portion 7A

The outer layer portions 7A are individually provided on the first surface A1 side and the second surface A2 side of the effective area 6. The outer layer portions 7A may be made of the same material as the dielectric layers 4 in the effective area 6.

### Side Gap Portion 7B

The side gap portions 7B are individually arranged on the fifth surface B1 side and the sixth surface B2 side of the effective area 6 in the multilayer body 2. The side gap portions 7B may be made of the same material as the dielectric layers 4.

### Outer Electrode 3

The outer electrodes 3 include the first outer electrode 3A and the second outer electrode 3B. The first outer electrode 3A is disposed on the third surface C1 and extends from the third surface C1 onto the first surface A1, the second surface A2, the fifth surface B1, and the sixth surface B2. The second outer electrode 3B is disposed on the fourth surface C2 and extends from the fourth surface C2 onto the first surface A1, the second surface A2, the fifth surface B1, and the sixth surface B2. Hereinafter, when it is not necessary to distinguish between the first outer electrode 3A and the second outer electrode 3B, they are collectively described as the outer electrodes 3.

The outer electrodes 3 each include an underlying electrode 30, which is disposed on the outer surface of the multilayer body 2, and a plating layer 31, which is disposed on the underlying electrode 30. The underlying electrode 30 mainly includes, for example, Cu and includes a glass component. The underlying electrode 30 includes, for example, Cu as a component.

The plating layer 31 preferably includes an intermediate plating layer disposed on the underlying electrode 30 and a surface plating layer disposed on the intermediate plating layer. In the first example embodiment, the intermediate plating layer is, for example, a Ni plating layer 31a, and the surface plating layer is, for example, a Sn plating layer 31b.

The Ni plating layer 31a prevents the underlying electrode 30 from eroding due to the solder used to mount ceramic electronic components. The Sn plating layer 31b improves the solder wettability during the mounting of the multilayer ceramic capacitor 1, facilitating the mounting of the multilayer ceramic capacitor 1.

### Inside Region 32, Outside Region 33

The underlying electrode 30 includes inside regions 32, which are arranged on the outer surface of the multilayer body 2 and extend, for example, about 1 μm or less from the outer surface of the multilayer body 2. The underlying electrode 30 includes outside regions 33, which extend, for example, about 1 μm or less from the outermost surface of the underlying electrode 30, that is, about 1 μm or less inward from the plating layer 31.

### First Outer Electrode 3A

The first outer electrode 3A includes a first underlying electrode 30A, which is disposed on the third surface C1, the first surface A1, the second surface A2, the fifth surface B1, and the sixth surface B2 of the multilayer body 2, and the plating layer 31, which is disposed on the first underlying electrode 30A.

The inside regions 32 of the first underlying electrode 30A include, for example, a third-surface inside region 32C1, which extends about 1 μm or less from the third surface C1, a first-surface inside region 32A1, which extends about 1 μm or less from the first surface A1, a second-surface inside region 32A2, which extends about 1 μm or less from the second surface A2, a fifth-surface inside region 32B1, which extends about 1 μm or less from the fifth surface B1, and a sixth-surface inside region 32B2, which extends about 1 μm or less from the sixth surface B2.

The outside regions 33 of the first underlying electrode 30A include, for example, a third-surface outside region 33C1, which is disposed on the third surface C1 and extends about 1 μm or less from the outermost surface of the underlying electrode 30, a first-surface outside region 33A1, which is disposed on the first surface A1 and extends about 1 μm or less from the outermost surface of the underlying electrode 30, a second-surface outside region 33A2, which is disposed on the second surface A2 and extends about 1 μm or less from the outermost surface of the underlying electrode 30, a fifth-surface outside region 33B1, which is disposed on the fifth surface B1 and extends about 1 μm or less from the outermost surface of the underlying electrode 30, and a sixth-surface outside region 33B2, which is disposed on the sixth surface B2 and extends about 1 μm or less from the outermost surface of the underlying electrode 30.

### Second Outer Electrode 3B

The second outer electrode 3B includes a second underlying electrode 30B, which is disposed on the fourth surface C2, the first surface A1, the second surface A2, the fifth surface B1, and the sixth surface B2 of the multilayer body 2, and the plating layer 31, which is disposed on the second underlying electrode 30B.

The inside regions 32 of the second underlying electrode 30B include, for example, a fourth-surface inside region 32C2, which extends about 1 μm or less from the fourth surface C2, a first-surface inside region 32A1, which extends about 1 μm or less from the first surface A1, a second-surface inside region 32A2, which extends about 1 μm or less from the second surface A2, a fifth-surface inside region 32B1, which extends about 1 μm or less from the fifth surface B1, and a sixth-surface inside region 32B2, which extends about 1 μm or less from the sixth surface B2.

The outside regions 33 of the second underlying electrode 30B include, for example, a fourth-surface outside region 33C2, which is disposed on the fourth surface C2 and extends about 1 μm or less from the outermost surface of the underlying electrode 30, a first-surface outside region 33A1, which is disposed on the first surface A1 and extends about 1 μm or less from the outermost surface of the underlying electrode 30, a second-surface outside region 33A2, which is disposed on the second surface A2 and extends about 1 μm or less from the outermost surface of the underlying electrode 30, a fifth-surface outside region 33B1, which is disposed on the fifth surface B1 and extends about 1 μm or less from the outermost surface of the underlying electrode 30, and a sixth-surface outside region 33B2, which is disposed on the sixth surface B2 and extends about 1 μm or less from the outermost surface of the underlying electrode 30.

(1-1) Ni Concentration of Inside Region on First surface A1 and Inside Region on Third Surface C1 or Fourth Surface C2

Preferably, the Ni concentrations of the first-surface inside regions 32A1 on the first surface A1, which defines and functions as the mounting surface, are lower than those of the third-surface inside region 32C1 or the fourth-surface inside region 32C2. Preferably, for example, the Ni concentrations of the first-surface inside regions 32A1 on the first surface A1, which defines and functions as the mounting surface, are between about 4.2% and about 8.68, inclusive. In this specification, % indicating concentrations is at. Preferably, for example, the Ni concentration of the third-surface inside region 32C1 or the fourth-surface inside region 32C2 is between about 20.8% and about 26.2%, inclusive. This can improve the moisture resistance of the multilayer ceramic capacitor 1 while ensuring the connection between the inner electrodes 5 and the outer electrodes 3.

In the first example embodiment, when the multilayer ceramic capacitor 1 is mounted on a substrate, bending or other deformations of the substrate may cause cracks to occur in the first surface A1 (the mounting surface) side of the multilayer body 2 due to stress from the bending or other deformations.

Herein, in portions of the underlying electrodes 30 provided on the first surface A1, the lower the Ni concentrations of the first-surface inside regions 32A1, the more densified the first-surface inside regions 32A1 of the underlying electrodes 30. When the Ni concentrations of the first-surface inside regions 32A1 drop below about 4.2%, cracks become less likely to occur in areas of the first surface A1 where the outer electrodes 3 are provided, and cracks become more likely to occur in areas where the outer electrodes 3 are not provided.

In portions of the underlying electrodes 30 provided on the first surface A1, the higher the Ni concentrations of the first-surface inside regions 32A1, the more voids are provided in the first-surface inside regions 32A1 of the underlying electrodes 30. When the Ni concentrations of the first-surface inside regions 32A1 exceed about 8.6%, the increased number of voids tends to cause deterioration in insulation resistance (IR) due to moisture ingress from the outside.

However, in the first example embodiment, the Ni concentrations of the first-surface inside regions 32A1 are lower than those of the third-surface inside region 32C1 or the fourth-surface inside region 32C2. In addition, for example, the Ni concentrations of the first-surface inside regions 32A1 are between about 4.2% and about 8.6%, inclusive. Therefore, cracks are less likely to occur in the outer surface of the multilayer body 2, and IR deterioration due to moisture ingress from the outside is less likely to occur.

### (1-2) Ni Concentration of Inside Region on Second Surface A2, Fifth Surface B1, and Sixth Surface B2, Other Than First Surface A1

Preferably, in a similar manner to the Ni concentrations of the first-surface inside regions 32A1, for example, the Ni concentrations of the second-surface inside regions 32A2, the fifth-surface inside regions 32B1, and the sixth-surface inside regions 32B2 are also lower than those of the third-surface inside region 32C1 or the fourth-surface inside region 32C2 and are between about 4.2% and about 8.6%, inclusive.

If only the first-surface inside regions 32A1 include Ni concentrations that are lower than those of the third-surface inside region 32C1 or the fourth-surface inside region 32C2 and the Ni concentrations thereof are between about 4.2% and about 8.6%, inclusive, it is necessary to identify the first surface A1 as the mounting surface during the mounting of the multilayer ceramic capacitor 1 on a substrate. However, for example, when not only the first-surface inside regions 32A1 but also the second-surface inside regions 32A2, the fifth-surface inside regions 32B1, and the sixth-surface inside regions 32B2 have Ni concentrations that are lower than those of the third-surface inside region 32C1 or the fourth-surface inside region 32C2 and the Ni concentrations thereof are between about 4.2% and about 8.68, inclusive, any surface can be used as the mounting surface, and it is not necessary to determine the orientation of the multilayer ceramic capacitor 1 during the mounting process.

### (2-1) Ni Concentration Ratio of Inside Region 32 on First Surface A1 to Inside Region 32 on Third Surface C1 or Fourth Surface C2

Furthermore, for example, it is preferable that the Ni concentration ratios that are calculated by dividing the Ni concentrations of the first-surface inside regions 32A1 by the Ni concentration of the inside region 32 on the third surface C1 or the fourth surface C2 are between about 20.19% and about 32.82%, inclusive.

### (2-2) Ni Concentration Ratio of Inside Region 32 on Second Surface A2, Fifth Surface B1, and Sixth Surface B2, Other Than First Surface A1, to Inside Region 32 on Third Surface C1 or Fourth Surface C2

Preferably, for example, the Ni concentration ratios that are calculated by dividing the Ni concentrations of the second-surface inside regions 32A2, the fifth-surface inside regions 32B1, and the sixth-surface inside regions 32B2 as well as the first-surface inside regions 32A1 by the Ni concentration of the third-surface inside region 32C1 are between about 20.19% and about 32.82%, inclusive.

(3-1) Ni Concentration Comparison between Inside Region 32 and Outside Region 33 on First Surface A1

Preferably, the Ni concentration of each first-surface inside region 32A1 is higher than that of the corresponding first-surface outside region 33A1. When the Ni concentration of each first-surface inside region 32A1, which is closer to the multilayer body 2, is set higher than that of the corresponding first-surface outside region 33A1, the advantageous effect of preventing moisture ingress into the multilayer body 2 can be improved. This can reduce or prevent deterioration in moisture resistance.

(3-2) Ni Concentration Comparison between Inside Region 32 and Outside Region 33 on Second Surface A2, Fifth Surface B1, and Sixth Surface B2, Other Than First Surface A1

Preferably, the Ni concentrations of the inside regions 32 are higher than those of the outside regions 33 on the second surface A2, the fifth surface B1, and the sixth surface B2 as well as on the first surface A1. When the Ni concentration of each inside region 32, which is closer to the multilayer body 2, is set higher than that of the corresponding outside region 33 even on those surfaces, the advantageous effect of preventing moisture ingress into the multilayer body 2 can be improved. This can reduce or prevent deterioration in moisture resistance.

### (4-1) Glass Concentration of Inside Region 32 on First Surface A1

Preferably, for example, the glass concentrations of the first-surface inside regions 32A1 are between about 1.0% and about 6.0%, inclusive. Providing glass in the interface between the multilayer body 2 and the underlying electrodes 30 can further reduce moisture ingress. When the glass concentrations decrease, the reduction in adhesion strength between each underlying electrode 30 and the multilayer body 2 can further facilitate the release of stress applied to the multilayer body 2.

### (4-2) Glass Concentration of Inside Region on Second Surface A2, Fifth Surface B1, and Sixth Surface B2, Other Than First Surface A1

It is preferable that, with respect to the glass concentrations, the second-surface inside regions 32A2, the fifth-surface inside regions 32B1, and the sixth-surface inside regions 32B2 also have the same or substantially the same concentration range as the first-surface inside regions 32A1.

This eliminates the need to determine the orientation of the multilayer ceramic capacitor 1 during the mounting process. In addition, the moisture ingress from the outside can be prevented in not only the first-surface inside regions 32A1 but also in the second-surface inside regions 32A2, the fifth-surface inside regions 32B1, and the sixth-surface inside regions 32B2.

Furthermore, it is preferable that the glass concentration of each first-surface inside region 32A1 is lower than that of the corresponding first-surface outside region 33A1. This can reduce the adhesion strength between each underlying electrode 30 and the plating layer 31 without excessively strengthening the adhesion between the multilayer body 2 and the outer electrodes 3. It is therefore possible to release external stress not only between each underlying electrode 30 and the multilayer body 2 but also between each underlying electrode 30 and the plating layer 31, thus reducing or preventing the propagation of cracks in the multilayer body 2.

### Measuring Method of Ni Concentration of Each Region

The Ni concentrations of the first-surface inside regions 32A1 to the sixth-surface inside regions 32B2 are measured, for example, in the following manner.

For example, the multilayer ceramic capacitor 1 is ground in the second direction W down to about half of the dimension of the multilayer ceramic capacitor 1 to expose a cross-section along the height direction T and the first direction L. Then, the measurement of the first-surface inside regions 32A1 is performed using a field emission scanning electron microscope (FE-SEM/EDX) at a magnification of about 5000 and a field of view of about 1.0 μm×about 1.0 μm. The measurement of the first-surface inside regions 32A1, the second-surface inside regions 32A2, the third-surface inside region 32C1, and the inside region 32C2 on the fourth surface can be conducted in the same cross-section.

During the measurement, the third-surface inside region 32C1 and the fourth-surface inside region 32C2 are observed from a location at about half of its dimension in the height direction T, with a field of view of about 1.0 μm×about 1.0 μm.

The Ni concentration of each region can be defined as the ratio of the number of Ni atoms to the total number of Ni and Cu atoms in the observed field of view, expressed as a percentage. The glass concentration of each region can be defined as the ratio of the number of Si atoms to the total number of Si, Cu, and Ni in the observed field of view, expressed as a percentage.

### Manufacturing Method

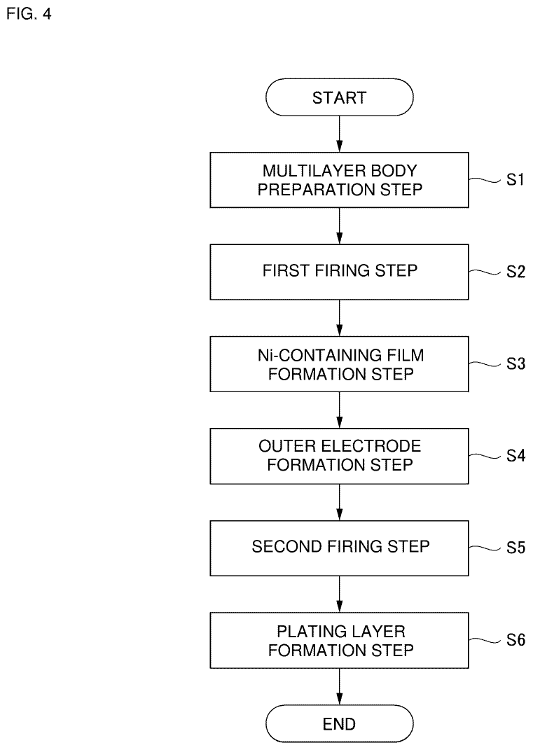

Next, a non-limiting example of a manufacturing method of the multilayer ceramic capacitor 1 according to the first example embodiment will be described. FIG. 4 is a flowchart of the manufacturing method of the multilayer ceramic capacitor 1 according to the first example embodiment.

### Multilayer Body Preparation Step S1

First, material sheets are prepared in which patterns of the inner electrodes 5 are printed with conductive paste on ceramic green sheets for stacking, which are sheets formed from ceramic slurry. The plural material sheets are stacked on top of each other such that the pattern of the inner electrodes 5 in each material sheet is shifted by about half the pitch in the length direction relative to that in the adjacent sheet. On both sides of the stack of the plural material sheets, ceramic green sheets for outer layer portions, which will define and function as the outer layer portions, are stacked and thermocompression-bonded to form a mother block. The mother block is divided along cutting lines to prepare the multilayer body 2.

### First Firing Step S2

The prepared multilayer body 2 is degreased in a nitrogen atmosphere under predetermined conditions and then fired at a predetermined temperature in a nitrogen-hydrogen-water vapor mixed atmosphere.

### Ni-Including Film Formation Step S3

In the fired multilayer body 2, for example, the portion other than the regions on the first surface A1, the second surface A2, the fifth surface B1, and the sixth surface B2 where the inside regions 32 need to be formed is masked, and Ni/Cu film is applied by sputtering or the like. In this process, the ratio of Ni in the Ni/Cu film is, for example, between about 60% and about 70%, inclusive.

### Outer Electrode Formation Step S4

Thereafter, paste for underlying electrodes, which will define and function as the underlying electrodes 30, is applied to the third surface C1 and the fourth surface C2 by using, for example, dip coating.

### Second Firing Step S5

Subsequently, the resultant product is fired, for example, at a firing temperature of about 800° C. for about 10 to about 15 minutes in an oxidation atmosphere where nitrogen and water are continuously supplied. The Ni concentration of the first-surface inside regions 32A1 is set, for example, between about 4.2% and about 8.6%, inclusive. During this process, Ni in the inner electrodes 5 penetrates the third-surface inside region 32C1 and the fourth-surface inside region 32C2. However, if the firing temperature is excessively high or the firing time is excessively long, the excessively high Ni content of the third-surface inside region 32C1 or the fourth-surface inside region 32C2 leads to deterioration in moisture resistance. Therefore, the firing temperature is set to about 800° C., and the firing time is set between about 10 and about 15 minutes, inclusive, for example.

### Plating Layer Formation Step S6

In the subsequent step, first, the Ni plating layers 31a are formed on the outer periphery of the underlying electrodes 30 so as to cover the respective underlying electrodes 30. Next, the Sn plating layers 31b are formed on the outer periphery of the Ni plating layers 31a so as to cover the respective Ni plating layers 31a. The multilayer ceramic capacitor 1 is manufactured through the above-described steps.

### Advantageous Effects Verification of Multilayer Ceramic Capacitor 1 of First Example Embodiment

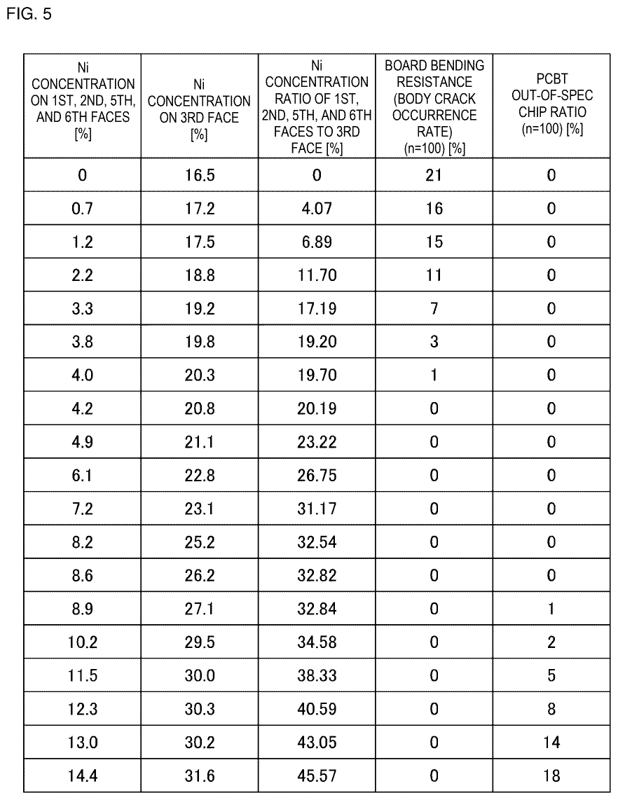

The multilayer ceramic capacitors 1 below were prepared, in which the Ni concentrations on the first surface A1 and on the third surface C1 were varied, and the results of their board bending resistance test and moisture resistance test described below will be explained. FIG. 5 is a table showing the results of the board bending resistance test and the moisture resistance test.

In the multilayer ceramic capacitors 1, for example, the dimension in the height direction T was about 0.2 mm±0.02 mm, the dimension in the first direction L was about 0.5 mm±0.2 mm, and the dimension in the second direction W was about 1.0 mm±0.2 mm. The dielectric layers 4 mainly included BaTio₃, and the inner electrodes 5 mainly included Ni. Each outer electrode 3 included the underlying electrode 30 mainly include Cu, the Ni plating layer 31a, and the Sn plating layer 31b, for example.

### Board Bending Resistance Test

The multilayer ceramic capacitors 1 were mounted on a 0.8 mm-thick substrate. Then, about 2.0 mm bending was conducted for the opposite surface to the surface where the multilayer ceramic capacitors 1 were mounted. The number of multilayer bodies 2 in which cracks occurred was counted.

### Result of Board Bending Resistance Test

As shown in the table of FIG. 5, when the Ni concentration of the first-surface inside regions 32A1 was lower than or equal to about 4.08, which was lower than about 4.2%, cracks occurred in the multilayer bodies 2 during the board bending resistance test, and the lower the Ni concentration of the first-surface inside regions 32A1, the greater the number of multilayer bodies 2 in which cracks occurred. In contrast, no cracks occurred in the multilayer bodies 2 during the board bending resistance test when the Ni concentration of the first-surface inside regions 32A1 was higher than or equal to about 4.2%.

With respect to the Ni concentration on the third surface C1, when the Ni concentration was lower than or equal to about 20.3%, which was lower than about 20.88, cracks occurred in the multilayer bodies 2 during the board bending resistance test, and the lower the Ni concentration on the third surface C1, the greater the number of multilayer bodies 2 in which cracks occurred. In contrast, no cracks occurred in the multilayer bodies 2 during the board bending resistance test when the Ni concentration on the third surface C1 was greater than or equal to about 20.8%.

With respect to the Ni concentration ratio that is calculated by dividing the Ni concentration of the first-surface inside regions 32A1 by the Ni concentration on the third surface C1, when the Ni concentration ratio is lower than or equal to about 19.70%, which is lower than about 20.198, cracks occurred in the multilayer bodies 2 during the board bending resistance test. The lower the Ni concentration ratio, the greater the number of multilayer bodies 2 in which cracks occurred. In contrast, no cracks occurred in the multilayer bodies 2 during the board bending resistance test when the Ni concentration ratio was greater than or equal to about 20.19%.

### Moisture Resistance Test

The multilayer ceramic capacitors 1 were mounted and were tested using the pressure cooker bias test (PCBT) at a temperature of about 125° C., a humidity of about 95%, a voltage of about 4V, and a testing time of about 144 hr. The PCBT is a test to accelerate and evaluate the impact of high temperature and humidity on deterioration in characteristics. Thereafter, the number of multilayer ceramic capacitors 1 whose insulation resistance (IR) had decreased by one order of magnitude or more was counted as defective products (out-of-spec chips). The total number n of multilayer ceramic capacitors 1 for each Ni concentration level was set to 100, and the experiment results are shown in FIG. 5.

As shown in the table, when the Ni concentration of the first-surface inside regions 32A1 was higher than or equal to about 8.9%, which was higher than about 8.6%, defective products occurred during the PCBT test. The higher the Ni concentration of the first-surface inside regions 32A1, the greater the number of defective products. In contrast, no defective product occurred when the Ni concentration of the first-surface inside regions 32A1 was lower than or equal to about 8.6%.

When the Ni concentration on the third surface C1 was higher than or equal to about 27.1%, which was higher than about 26.2%, the higher the Ni concentration on the third surface C1, the greater the number of defective products. In contrast, no defective product occurred when the Ni concentration on the third surface C1 was lower than or equal to about 26.2%.

With respect to the Ni concentration ratio that is calculated by dividing the Ni concentration of the first-surface inside regions 32A1 by the Ni concentration on the third surface C1, when the Ni concentration ratio was higher than or equal to about 32.84%, which was higher than about 32.82%, defective products occurred, and the higher the Ni concentration ratio, the greater the number of defective products. In contrast, no defective product occurred during the PCBT test when the Ni concentration ratio was lower than or equal to about 32.82%.

As described above, when the Ni concentration of the first-surface inside regions 32A1 was in the preferable range from, for example, about 4.2% to about 8.6% of the first example embodiment, it was demonstrated that sufficient bending strength was achieved and the moisture resistance was high.

Furthermore, when the Ni concentration on the third surface C1 was, for example, in the preferable range from about 20.8% to about 26.2% of the first example embodiment, it was demonstrated that sufficient bending strength was achieved and the moisture resistance was high.

Still furthermore, for example, when the Ni concentration ratio that was calculated by dividing the Ni concentration of the first-surface inside regions 32A1 by the Ni concentration on the third surface C1, was between about 20.19% and about 32.82%, inclusive, it was demonstrated that sufficient bending strength was achieved and the moisture resistance was also high.

### Second Example Embodiment

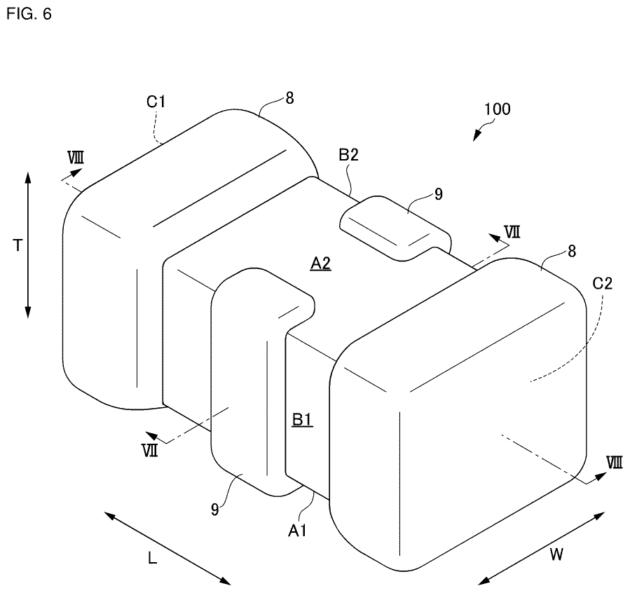

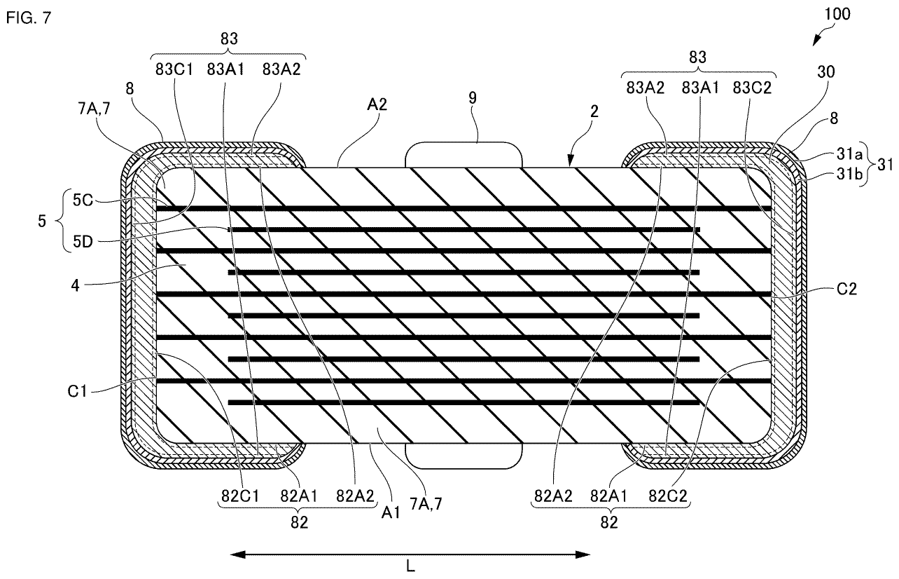

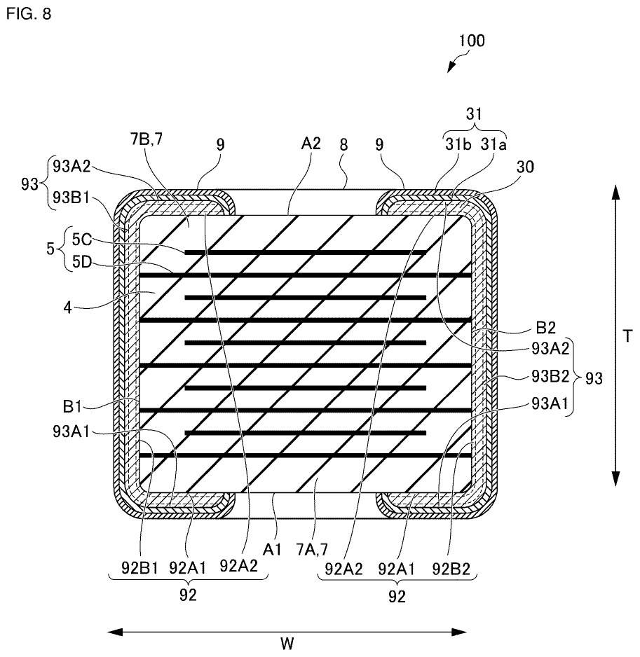

Next, a multilayer ceramic capacitor 100 according to a second example embodiment of the present invention will be described. FIG. 6 is a schematic perspective view of the multilayer ceramic capacitor 100 according to the second example embodiment. FIG. 7 is a partial sectional view of the multilayer ceramic capacitor 100 along line VII-VII in FIG. 6. FIG. 8 is sectional view of the multilayer ceramic capacitor 100 along line VIII-VIII in FIG. 6.

The multilayer ceramic capacitor 100 according to the second example embodiment is a three-terminal multilayer ceramic capacitor 100. The second example embodiment is different from the first example embodiment in inner electrode shape and outer electrodes. The other portions of the second example embodiment, which are the same or substantially the same as those of the multilayer ceramic capacitor 1 of the first example embodiment, are denoted by the same reference numerals, and the description thereof is omitted.

### Inner Electrode 5

The inner electrodes 5 include plural first-direction exposed inner electrodes 5C and plural second-direction exposed inner electrodes 5D.

The first-direction exposed inner electrodes 5C extend between the third surface C1 and the fourth surface C2 on both sides of the multilayer body 2 in the first direction L and are spaced a certain distance from the fifth surface B1 and the sixth surface B2 on both sides in the second direction W.

The second-direction exposed inner electrodes 5D extend between the fifth surface B1 and the sixth surface B2 on both sides of the multilayer body 2 in the second direction W and are spaced from the third surface C1 and the fourth surface C2 on both sides in the first direction L.

On the third surface C1 and the fourth surface C2 of the multilayer body 2, first-direction outer electrodes 8 (first and second outer electrodes) are provided. The first-direction exposed inner electrodes 5C are coupled to the first-direction outer electrodes 8. Each of the first-direction outer electrodes 8 covers not only the third surface C1 or fourth surface C2 but also certain portions of the first surface A1, second surface A2, fifth surface B1 and the sixth surface B2, in the same or similar manner to the outer electrodes 3 of the first example embodiment.

On the fifth surface B1 and the sixth surface B2 of the multilayer body 2, second-direction outer electrodes 9 are provided. The second-direction exposed inner electrodes 5D are coupled to the second-direction outer electrodes 9. The second-direction outer electrodes 9 cover not only the fifth surface B1 and the sixth surface B2 but also cover certain portions of the first surface A1 and second surface A2.

In the same or similar manner to the outer electrodes 3 of the first example embodiment, each of the first-direction outer electrodes 8 and the second-direction outer electrodes 9 includes an underlying electrode 30, which is disposed on the outer surface of the multilayer body 2, and a plating layer 31, which is disposed on the underlying electrode 30. The plating layer 31 preferably includes an intermediate plating layer disposed on the underlying electrode 30 and a surface plating layer disposed on the intermediate plating layer. In the second example embodiment, for example, the intermediate plating layer is a Ni plating layer 31a, and the surface plating layer is a Sn plating layer 31b.

### First-Direction Outer Electrode 8

In each first-direction outer electrode 8, for example, the underlying electrode 30 includes inside regions 82, which are arranged on the outer surface of the multilayer body 2 and extend about 1 μm or less from the outer surface of the multilayer body 2. The underlying electrode 30 further includes outside regions 83, which are regions extending, for example, about 1 μm or less from the outermost surface of the underlying electrode 30, that is, regions extending about 1 μm or less inward from the plating layer 31.

### (1-1) Ni Concentration of Inside Region 82 on First Surface A1 and Ni Concentration of Inside Region 82 on Third Surface C1 or Fourth Surface C2

In each first-direction outer electrode 8, preferably, the Ni concentration of a first-surface inside region 82A1 on the first surface A1, which defines and functions as the mounting surface, is lower than that of a third-surface inside region 82C1 or a fourth-surface inside region 82C2. In each first-direction outer electrode 8, preferably, for example, the Ni concentration of the first-surface inside region 82A1 on the first surface A1, which defines and functions as the mounting surface, is between about 4.2% and about 8.6%, inclusive. The Ni concentration of the third-surface inside region 82C1 or the fourth-surface inside region 82C2 is, for example, preferably between about 20.8% and about 26.2%, inclusive. This can improve the moisture resistance of the multilayer ceramic capacitor 100 while ensuring the connection between the inner electrodes 5 and the first-direction outer electrodes 8.

In the second example embodiment, the Ni concentrations of the first-surface inside regions 82A1 are lower than those of the third-surface inside region 82C1 or the fourth-surface inside region 82C2. The Ni concentrations of the first-surface inside regions 82A1 are, for example, between about 4.2% and about 8.6%, inclusive. Therefore, cracks are less likely to occur in the outer surface of the multilayer body 2, and IR deterioration due to moisture ingress from the outside is less likely to occur.

### (1-2) Ni Concentration of Inside Region on Second Surface A2, Fifth Surface B1, and Sixth Surface B2, Other Than First Surface A1

In each first-direction outer electrode 8, preferably, the Ni concentrations of a second-surface inside region 82A2, a fifth-surface inside region 82B1, and a sixth-surface inside region 82B2, in a similar manner to the Ni concentration of the first-surface inside region 82A1, are lower than those of the third-surface inside region 82C1 or the fourth-surface inside region 82C2 and, for example, are between about 4.2% and about 8.6%, inclusive.

This allows either the first surface A1 or the second surface A2 to be used as the mounting surface, thus eliminating the need to determine the orientation of the multilayer ceramic capacitor 100 during the mounting process.

### (2-1) Ni Concentration Ratio of Inside Region 82 on First Surface A1 to Inside Region 82 on Third Surface C1 or Fourth Surface C2

In each first-direction outer electrode 8, preferably, for example, the Ni concentration ratio that is calculated by dividing the Ni concentration of the first-surface inside region 82A1 by the Ni concentration of the inside region 82 on the third surface C1 or the fourth surface C2, is between about 20.19% and about 32.82%, inclusive.

### (2-2) Ni Concentration Ratio of Inside Region 82 on Second Surface A2, Fifth Surface B1, and Sixth Surface B2, Other Than First Surface A1, to Inside Region 82 on Third Surface C1 or Fourth Surface C2

The Ni concentration ratios that are calculated by dividing the Ni concentrations of the second-surface inside region 82A2, the fifth-surface inside region 82B1, and the sixth-surface inside region 82B2 as well as the first-surface inside region 82A1 by the Ni concentration of the third-surface inside region 82C1 are, for example, between about 20.19% and about 32.82%, inclusive.

(3-1) Ni Concentration Comparison between Inside Region 82 and Outside Region 83 on First Surface A1

In each first-direction outer electrode 8, preferably, the Ni concentration of the first-surface inside region 82A1 is higher than that of a first-surface outside region 83A1. When the Ni concentration of the first-surface inside region 82A1, which is closer to the multilayer body 2, is set higher than that of the first-surface outside region 83A1, the advantageous effect of reducing or preventing moisture ingress into the multilayer body 2 can be improved. This can reduce or prevent deterioration in moisture resistance.

(3-2) Ni Concentration Comparison between Inside Region 82 and Outside Region 83 on Second Surface A2, Fifth Surface B1, and Sixth Surface B2, Other Than First Surface A1

In each first-direction outer electrode 8, preferably, the Ni concentrations of the inside regions 82 are higher than those of the outside regions 83 on the second surface A2, the fifth surface B1, and the sixth surface B2 as well as on the first surface A1. When the Ni concentration of each inside region 82, which is closer to the multilayer body 2, is set higher than that of the corresponding outside region 83 even on those surfaces, the advantageous effect of reducing or preventing moisture ingress into the multilayer body 2 can be improved. This can reduce or prevent deterioration in moisture resistance.

### (4-1) Glass Concentration of First-Surface Inside Region 82A1

In each first-direction outer electrode 8, preferably, the glass concentration of the first-surface inside region 82A1 is, for example, between about 1.0% and about 6.0%, inclusive. Providing glass in the interface between the multilayer body 2 and the underlying electrode 30 can further reduce or prevent moisture ingress. Furthermore, when the glass concentration decreases, the reduction in adhesion strength between the underlying electrode 30 and the multilayer body 2 can further facilitate the release of stress applied to the multilayer body 2.

### (4-2) Glass Concentration of Inside Region on Second Surface A2, Fifth Surface B1, and Sixth Surface B2, Other Than First Surface A1

In each first-direction outer electrode 8, preferably, the glass concentrations of the second-surface inside region 82A2, the fifth-surface inside region 82B1, and the sixth-surface inside region 82B2 are also, for example, between about 1.0% and about 6.0%, inclusive.

In each first-direction outer electrode 8, preferably, the glass concentration of the first-surface inside region 82A1 is lower than the glass concentration of the first-surface outside region 83A1.

### Second-Direction Outer Electrode 9

In each second-direction outer electrode 9, the underlying electrode 30 includes inside regions 92, which are arranged on the outer surface of the multilayer body 2 and, for example, extend about 1 μm or less from the outer surface of the multilayer body 2. The underlying electrode 30 further includes outside regions 93, which are, for example, regions extending about 1 μm or less from the outermost surface of the underlying electrode 30, that is, regions extending about 1 μm or less inward from the plating layer 31.

### (1-1) Ni Concentration of Inside Region 92 on First Surface A1 and Ni Concentration of Inside Region 922 on Fifth Surface B1 or Sixth Surface B2

In each second-direction outer electrode 9, preferably, the Ni concentration of a first-surface inside region 92A1 on the first surface A1, which define and functions as the mounting surface, is lower than that of a fifth-surface inside region 92B1 or a sixth-surface inside region 92B2. In the second-direction outer electrode 9, for example, preferably, the Ni concentration of the first-surface inside region 92A1 is between about 4.2% and about 8.6%, inclusive. The Ni concentration of the fifth-surface inside region 92B1 or the sixth-surface inside region 92B2 is, for example, preferably between about 20.8% and about 26.2%, inclusive. This can improve the moisture resistance of the multilayer ceramic capacitor 100 while ensuring the connection between the inner electrodes 5 and the second-direction outer electrodes 9.

In the second example embodiment, the Ni concentrations of the first-surface inside regions 92A1 are lower than those of the fifth-surface inside region 92B1 or the sixth-surface inside region 92B2. The Ni concentrations of the first-surface inside regions 92A1 are, for example, between about 4.2% and about 8.6%, inclusive. Therefore, cracks are less likely to occur in the outer surface of the multilayer body 2, and IR deterioration due to moisture ingress from the outside is less likely to occur.

### (1-2) Ni Concentration of Inside Region on Second Surface A2, Other Than First Surface A1

In each second-direction outer electrode 9, preferably, the Ni concentration of the second-surface inside region 92A2, in the same or similar manner to the Ni concentration of the first-surface inside region 92A1, is lower than that of the fifth-surface inside region 92B1 or the sixth-surface inside region 92B2 and is, for example, between about 4.2% and about 8.6%, inclusive.

This allows either the first surface A1 or the second surface A2 to be used as the mounting surface, thus eliminating the need to determine the orientation of the multilayer ceramic capacitor 100 during the mounting process.

### (2-1) Ni Concentration Ratio of Inside Region 92 on First Surface A1 to Inside Region 92 on Fifth Surface B1 or Sixth Surface B2

In each second-direction outer electrode 9, preferably, the Ni concentration ratio that is calculated by dividing the Ni concentration of the first-surface inside region 92A1 by the Ni concentration of the inside region 92 on the fifth surface B1 or the sixth surface B2, is, for example, between about 20.19% and about 32.82%, inclusive.

### (2-2) Ni Concentration Ratio of Second-Surface Inside Region 92A2, Other Than on First Surface A1, to Inside Region 92 on Fifth Surface B1 or Sixth Surface B2

The Ni concentration ratios that are calculated by dividing the Ni concentration of the second-surface inside region 92A2 as well as the first-surface inside region 92A1 by the Ni concentrations of the fifth-surface inside region 92B1 or the sixth-surface inside region 92B2, are, for example, between about 20.19% and about 32.82%, inclusive.

(3-1) Ni Concentration Comparison between Inside Region and Outside Region on First Surface A1

In each second-direction outer electrode 9, preferably, the Ni concentration of the first-surface inside region 92A1 is higher than that of the first-surface outside region 93A1. When the Ni concentration of the first-surface inside region 92A1, which is closer to the multilayer body 2, is set higher than that of the first-surface outside region 93A1, the advantageous effect of reducing or preventing moisture ingress into the multilayer body 2 can be improved. This can reduce or prevent deterioration in moisture resistance.

(3-2) Ni Concentration Comparison between Inside Region 92 and Outside Region 93 on Second Surface A2

In each second-direction outer electrode 9, preferably, the Ni concentrations of the inside regions 92 are higher than those of the outside regions 93 on the second surface A2 as well as on the first surface A1.

### (4-1) Glass Concentration of First-Surface Inside Region 92A1

In each second-direction outer electrode 9, preferably, the glass concentration of the first-surface inside region 92A1 is, for example, between about 1.0% and about 6.0%, inclusive. providing glass in the interface between the multilayer body 2 and the underlying electrode 30 can further reduce or prevent moisture ingress. Furthermore, when the glass concentration decreases, the reduction in adhesion strength between the underlying electrode 30 and the multilayer body 2 can further facilitate the release of stress applied to the multilayer body 2.

### (4-2) Glass Concentration of Inside Region on Second Surface A2

In each second-direction outer electrode 9, preferably, the glass concentration of the second-surface inside region 92A2 is, for example, also between about 1.0% and about 6.0%, inclusive.

This can eliminate the need to determine the orientation of the multilayer ceramic capacitor 100 during the mounting process. Furthermore, moisture ingress from the outside can be reduced or prevented not only in the first-surface inside region 92A1 but also in the second-surface inside region 92A2, the fifth-surface inside region 82B1, and the sixth-surface inside region 82B2.

As described above, the second d example embodiment provides the same or substantially the same advantageous effects as the first example embodiment.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including:
a first surface and a second surface facing each other in a height direction;
a third surface and a fourth surface facing each other in a first direction perpendicular or substantially perpendicular to the height direction;
a fifth surface and a sixth surface facing each other in a second direction perpendicular or substantially perpendicular to the height direction and the first direction;
an internal electrode exposed at the first surface; and
a first outer electrode on the third surface, the first surface, the second surface, the fifth surface, and the sixth surface; and
a second outer electrode on the fourth surface, the first surface, the second surface, the fifth surface, and the sixth surface; wherein
the first outer electrode and the second outer electrode respectively include a first underlying electrode and a second underlying electrode including Cu;
the first underlying electrode includes:
a first-surface inside region on the first surface and extending about 1 μm or less from the first surface in the height direction;
a second-surface inside region on the second surface and extending about 1 μm or less from the second surface in the height direction;
a third-surface inside region on the third surface and extending about 1 μm or less from the third surface in the first direction;
a fifth-surface inside region on the fifth surface and extending about 1 μm or less from the fifth surface in the second direction; and
a sixth-surface inside region on the sixth surface and extending about 1 μm or less from the sixth surface in the second direction;
the first-surface inside region and the third-surface inside region include Ni; and
a Ni concentration of the first-surface inside region is lower than a Ni concentration of the third-surface inside region.

2. The multilayer ceramic capacitor according to claim 1, wherein the Ni concentration of the first-surface inside region is between about 4.2% and about 8.6%, inclusive.

3. The multilayer ceramic capacitor according to claim 2, wherein
the second-surface inside region includes Ni; and
a Ni concentration of the second-surface inside region is lower than the Ni concentration of the third-surface inside region and is between about 4.2% and about 8.6%, inclusive.

4. The multilayer ceramic capacitor according to claim 3, wherein
the fifth-surface inside region includes Ni; and
a Ni concentration of the fifth-surface inside region is lower than the Ni concentration of the third-surface inside region and is between about 4.2% and about 8.6%, inclusive.

5. The multilayer ceramic capacitor according to claim 1, wherein the Ni concentration of the third-surface inside region is between about 20.8% and about 26.2%, inclusive.

6. The multilayer ceramic capacitor according to claim 2, wherein the Ni concentration of the third-surface inside region is between about 20.8% and about 26.2%, inclusive.

7. The multilayer ceramic capacitor according to claim 3, wherein the Ni concentration of the third-surface inside region is between about 20.8% and about 26.2%, inclusive.

8. The multilayer ceramic capacitor according to claim 1, wherein the first-surface inside region includes glass at a concentration between about 1.0% and about 6.0%, inclusive.

9. The multilayer ceramic capacitor according to claim 2, wherein the first-surface inside region includes glass at a concentration between about 1.0% and about 6.0%, inclusive.

10. The multilayer ceramic capacitor according to claim 1, wherein
the first underlying electrode includes:
a first-surface outside region on the first surface and extending about 1 μm or less from an outermost surface of the first underlying electrode;
a second-surface outside region on the second surface and extending about 1 μm or less from the outermost surface of the first underlying electrode;
a third-surface outside region on the third surface and extending about 1 μm or less from the outermost surface of the first underlying electrode;
a fifth-surface outside region on the fifth surface and extending about 1 μm or less from the outermost surface of the first underlying electrode; and
a sixth-surface outside region on the sixth surface and extending about 1 μm or less from the outermost surface of the first underlying electrode;
the first-surface outside region includes Ni; and
the Ni concentration of the first-surface inside region is higher than a Ni concentration of the first-surface outside region.

11. The multilayer ceramic capacitor according to claim 10, wherein
the first-surface inside region and the first-surface outside region include glass; and
a glass concentration of the first-surface inside region is lower than a glass concentration of the first-surface outside region.

12. The multilayer ceramic capacitor according to claim 1, wherein
the multilayer body includes a plurality of dielectric layers and a plurality of inner electrodes laminated in the height direction;
the plurality of internal electrodes include a first internal electrode and a second internal electrode;
the first internal electrode is exposed at the third surface; and
the second internal electrode is exposed at the fourth surface.

13. The multilayer ceramic capacitor according to claim 1, wherein
the multilayer body includes a plurality of dielectric layers and a plurality of inner electrodes laminated in the height direction;
the plurality of internal electrodes include a first internal electrode and a second internal electrode;
the first internal electrode is exposed at the third surface and the fourth surface; and
the second internal electrode is exposed at the fifth surface and sixth surface.

14. The multilayer ceramic capacitor according to claim 13, further comprising:
a third outer electrode on the fifth surface, the first surface, and the second surface; and
a fourth outer electrode on the sixth surface, the first surface, and the second surface.

15. The multilayer ceramic capacitor according to claim 14, wherein
the third outer electrode and the fourth outer electrode respectively include a third underlying electrode and a fourth underlying electrode including Cu;
the third underlying electrode includes:
a first-surface inside region on the first surface and extending about 1 μm or less from the first surface in the height direction; and
a fifth-surface inside region on the fifth surface and extending about 1 μm or less from the fifth surface in the height direction.

16. The multilayer ceramic capacitor according to claim 15, wherein a Ni concentration of the first-surface inside region of the third underlying electrode is between about 4.2% and about 8.6%, inclusive.

17. The multilayer ceramic capacitor according to claim 16, wherein the first-surface inside region of the third underlying electrode includes glass at a concentration between about 1.0% and about 6.0%, inclusive.
